(19) United States
(12) Patent Application Publication
(10) Pub. No.: US 2014/0300082 A1
(43) Pub. Date: Oct. 9, 2014

(54) DOUBLE JOINT PIVOT UNIT WITH RUNNING GEAR FOR ROAD VEHICLES

(71) Applicant: István Szabó, (US)

(72) Inventor: István Szabó, Budapest (HU)

(21) Appl. No.: 14/355,917

(22) PCT Filed: Oct. 25, 2012
(86) PCT No.: PCT/HU2012/000110

§ 371 Date: May 2, 2014

(30) Foreign Application Priority Data
Nov. 2, 2011 (HU) P 11 00607

(51) Int. Cl. B60D 1/24; B60D 1/01

(52) U.S. Cl. CPC B60D 1/24; B60D 1/01
USPC 280/492

(57) ABSTRACT

The subject of the invention is double pivot joint unit with running gear for road vehicles, which beneficially influences the turning ability and safety of the vehicle in a way that the turning lane is about half of the usual one, the swinging mass in the turn is significantly less, thereby the stability of the vehicle is significantly better. The joint unit (3) according to the invention is located between the front member (1) of the road vehicle and the rear member (2) of the vehicle, and the joint unit (3) has a structure consisting of rocker and linkages for preventing jack-knifing and for ensuring proportional turn, which is connected to the front member (1) of the vehicle and to the rear member (2) of the vehicle with rotating rings (4,5). It is characterised by that the joint unit (3) includes the intermediate axle (B) Or the vehicle or its twin axle (B1, B2), or the twin axles (B1, B2, B3, B4) of the intermediate joint units (3), and it has double pivots (13) along the longitudinal axis of the vehicle, and a structure that ensures proportional turn of the vehicle members.

The subject of the invention is double pivot joint unit with running gear for road vehicles, which beneficially influences the turning ability and safety of the vehicle in a way that the turning lane is about half of the usual one, the swinging mass in the turn is significantly less, thereby the stability of the vehicle is significantly better, relative to the traditional articulated vehicles.

One of the most important aspects of designing articulated vehicles is the safety of combined vehicle, as well as the related allowable velocity. Particularly, the divided vehicle body is to be protected from jack-knifing, as well as from the less critical tilting and wriggling. The phenomenon can be caused by the steering, braking or the quality of the road (route and unevenness) alike. The effect of these factors increases with the velocity, therefore, restriction are usually introduced for the allowed velocity of such combined vehicles. The extent of counter measures to be taken is significantly influenced by the actual loads of the combined vehicle. In addition to the improvement of driving technique of drivers, the safety can be increased also by improving the construction.

In case of the traditional articulated solution the length of the articulated vehicles can be increased only by improving the turning ability, because diameter and the width of the turning lane are limited. The methods for accomplishing this aim was to provide better steering geometry, and the introduction of steering of the rear axle in association with this.

The patent document HU 172 626 makes known articulated vehicle, particularly motor driven vehicle. According to the solution described in this document the wheel of the trailer is steered by the rocker mechanism connected to the towing vehicle. The rear wheel turns in proportion with the actual turning of the towing vehicle. This solution decreases the turning angle between the towing vehicle and the trailer by improving the turning ability, which is particularly important when the vehicle is started from the side of a sidewalk. This solution is widely used, in which the risk of swinging out still exists, although to a limited extent.

Similar solution makes known by the patent document HU 193 631, where the hinge mechanism controls the turning of the rear wheel with similar results. According to the patent document GB 2 068 860 the rear wheels are steered by a complicated linkage attached to the tractor. According to patent document GB 2 446 631 the double axle trailer is also controller by the tractor similarly to the method used in trucks. In both cases the rear wheels turn in a direction which is opposite to the turn of the front steered wheels, but the swinging out still remains.

A different approach is used in the solution makes known by the patent document HU 182100, which introduces an axle configuration used preferably for articulated vehicles. According to the solution described in this document, the rear member of the vehicle train has a driven non-steered rear axle, as well as a non-driven steered front axle. The front vehicle member has rigid axle. This unconventional configuration makes people uneasy, and therefore it is not very much used, although the turning properties of the vehicle are better than those of the traditional vehicle still in use.

The patent document DE 3232367 makes known a railbus design, which is suitable for travelling in both directions. According to the solution introduced in this document the wheels run free on the middle axle, and the centre of the axle coincides with the vertical axis of the hinge. The planned solution does not provide suitable space for the wheels in the hinge, and the hinge is too big, which gives rise to structural problems.

The patent document DE 3841772 makes known an articulated vehicle which can move in both directions along guided route. In this case the hinge accommodates the middle axle also, as a result of which the internal space of the vehicle can be configured in a more flexible manner. A feeler device is necessary for the steering. The guidance for the experimental vehicle was provided by a beam protruding from the carriageway. A separate bus lane had to be established because of it, however, this cannot be intersected by vehicle traffic. This is particularly problematic at crossings. The bus lane cannot be used for other purposes, for instance for rescuing operations. The steering conditions ensured by the fixing of middle axle limits the length of the vehicle substantially. The drawings in the patent are not to scale, the vehicle cannot provide the desired benefit, and this becomes clear only after preparing the drawings again.

The patent document DE 10 2006 037 588 uses a novel computerized approach for analysing the steering of multiple-axle vehicles. A vehicle with four axles and two hinges is introduced here, all the axles of which had to be steered, but the description uses software solution, and not structural solution. The German industrial sample description DE 202007012413 (U1) introduces a control system, which offers solution for the control of hinge angles, which can be different, of vehicles with two hinges. The design and axle configuration of the vehicle are traditional.

The drawbacks of the solutions known and used according to the state of art includes that the traditional articulated buses used in the urban traffic have extremely wide turning lane, which could not be reduced efficiently by the various known solutions. Because of the traditional axle configuration the stability during turning is acceptable only at low vehicle speed. Specifications for the turning lane necessarily limit the vehicle length, therefore, the carrying capacity of the vehicles cannot be increased.

The aim of developing the solution according to the invention was to improve the turning properties of articulated vehicles, particularly the increasing of turning ability and safety, as well as increasing the capacity of the vehicle.

During the development of the solution according to the invention it was recognised that if we use independent joint unit with double pivot between the primary vehicle members of articulated vehicles, then the vehicle will be able to receive intermediate running gear also, as a result of which the above mentioned problems can be resolved and the vehicle gets more beneficial running and stability properties. This recognition also allows the increase of vehicle length and carrying capacity, if the permitted turning lane is utilized.

The invention is a double pivot joint unit with running gear for road vehicles, which joint unit is located between the front member of the road vehicle and the rear member of the vehicle, and the joint unit has a structure consisting of rocker and linkages for preventing jack-knifing and for ensuring proportional turn, which is connected to the front member of the vehicle and to the rear member of the vehicle with rotating rings. It is characterised by that, the joint unit includes the intermediate axle or the vehicle or its twin axle, or the twin axles of the intermediate joint units, and it has double pivots along the longitudinal axis of the vehicle, and a structure that ensures proportional turn of the vehicle members.

In one preferred embodiment of the joint unit according to the invention the structure of joint unit, that ensures proportional turning, consists of two meshing sectors gears, one of which is integrated with one of the rings of one of the rotating ring, while the other sector ring or both of them are integrated with a respective rocker sector gear, and the rocker sector gears are connected directly with connecting rods, or through pitching joint to the vehicle members.

In another preferred embodiment of the joint unit according to the invention the two rocker sector gears are used in the joint unit, which are connected to the front member of the vehicle and to the rear member of the vehicle with connecting rods by means of hinged joint.

In a further preferred embodiment of the joint unit according to the invention rotating rings are installed in its pivots at identical centres, one ring of which are connected to the joint unit and the other ring of which are connected to the vehicle members, and one of the vehicle member is connected to pitching joint which is capable of rotating around a horizontal axis.

In a further preferred embodiment of the joint unit according to the invention a structure for preventing jack-knifing is installed symmetrically to the longitudinal axis of the vehicle, where hydraulic cylinders are connected through hinged joint to the structure of joint unit and to the rocker sector gear or to the intermediate rocker; and their chambers are interconnected with hydraulic pipes passed through the control unit, and the control unit works on the basis of information collected from the vehicle and commands received from the driver's stand through the control port.

In a further preferred embodiment of the joint unit according to the invention in its structure ensuring proportional articulation the radii of sector gears may be different, and/or the alignment of connecting rods may deviate from the parallel.

In a further preferred embodiment of the joint unit according to the invention hydraulic cylinders located symmetrically to the longitudinal axis of the vehicle combine the two functions of the structure of the joint unit, which ensures proportional articulations and provides protection against jack-knifing, which are connected to the structure of joint unit at one side, and are connected at the other side to the intermediate rockers with hinged joint, while the intermediate rockers are connected to the vehicle members through the connecting rods, and the chambers of the hydraulic cylinders are interconnected with hydraulic pipes, which are passed through control unit and routed properly, and the control unit operates the hydraulic cylinders on the basis of the information received from the vehicle through control port and the commands received from the driver's stand.

In a further preferred embodiment of the joint unit according to the invention the pitching movement of the vehicle is ensured by the pitching joint by means of the flexibly embedded horizontal shaft installed between the consoles and one of rings of the rotating ring of one of the vehicle member; or by means of the flexibly embedded horizontal shaft installed between the console of the vehicle member and pitching joint integrated with one of rings of the rotating ring.

In a further preferred embodiment of the joint unit according to the invention the twin axles of the joint unit are established with axle steering.

In a further preferred embodiment of the joint unit according to the invention more than one, in the given case two joint units are used between the front member of the vehicle and the rear member of the vehicle, which are connected to an intermediate vehicle unit.

The solution according to the invention is furthermore set forth by the enclosed drawings:

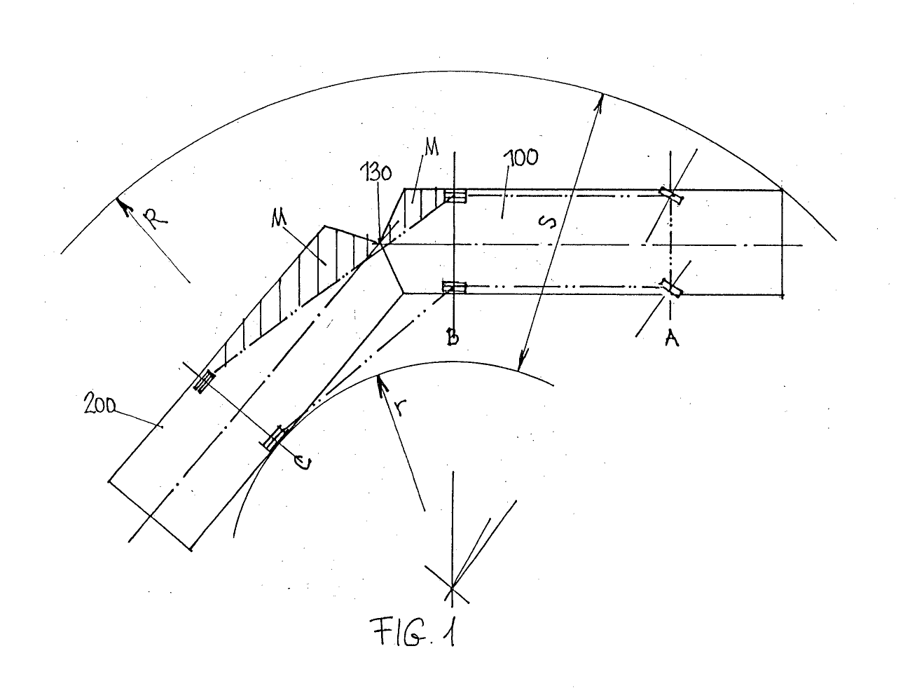

FIG. 1 shows the turning properties of the traditional articulated vehicles

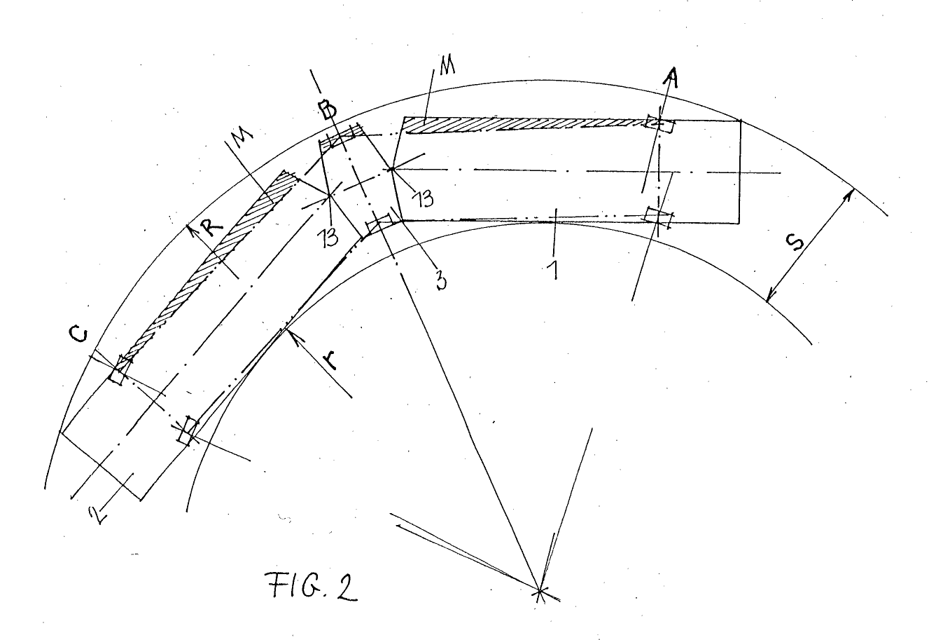

FIG. 2 shows the top view of an articulated vehicle during turning, which has a joint unit according to the invention, and having double pivots and single axle running gear.

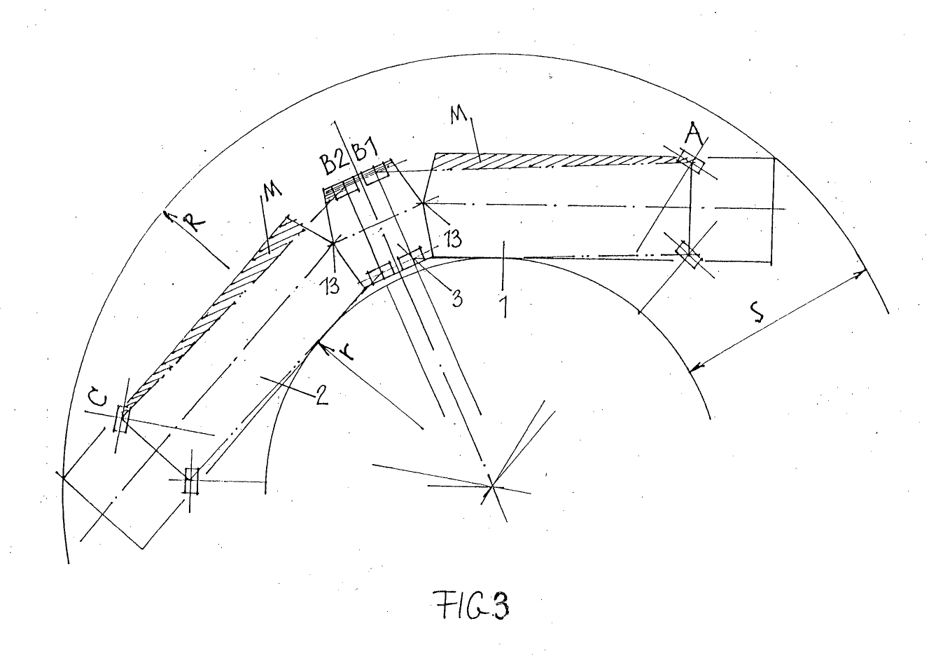

FIG. 3 shows the top view of an articulated vehicle during turning, which has a joint unit according to the invention, having twin axle running gear with double pivots.

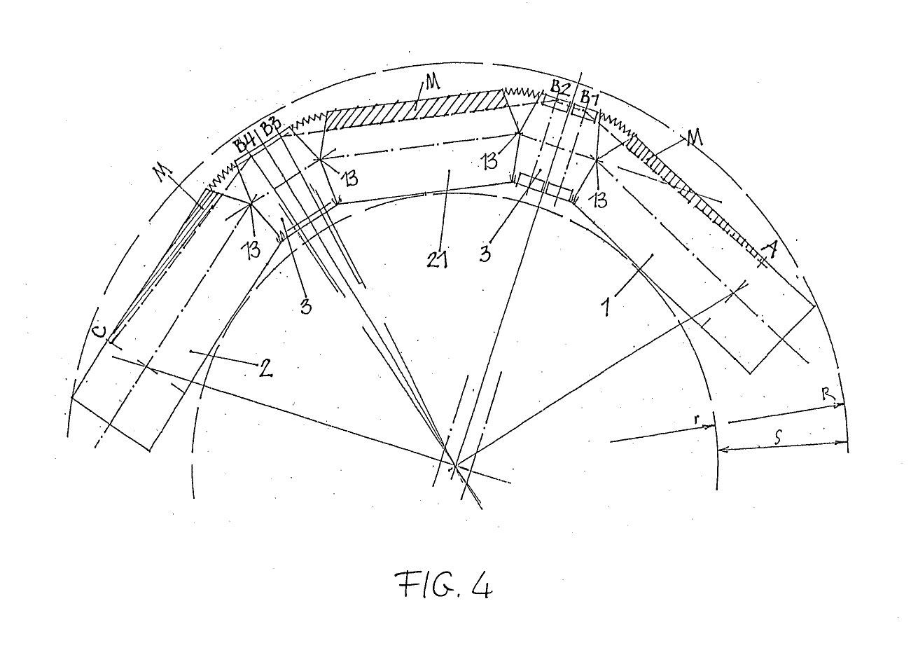

FIG. 4 shows the top view of a five-member articulated vehicle during turning, which has a joint unit according to the invention, connected with two joint units and running gear having double pivots and twin axles.

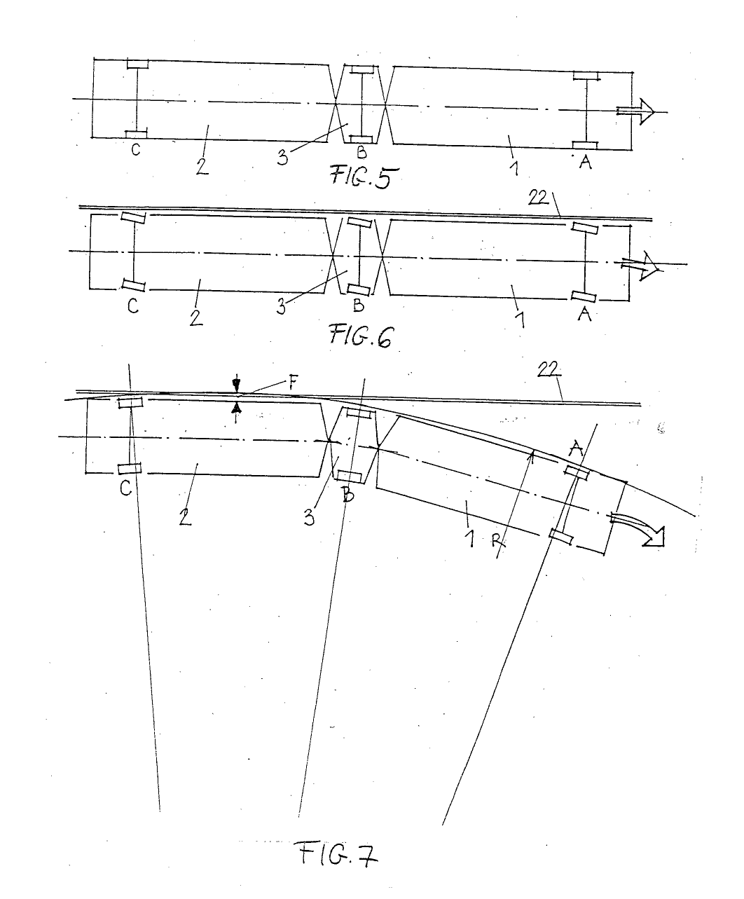

FIG. 5 shows the top vies of articulated vehicle provided with the joint unit according to the invention, connected with running gear joint having twin axle and double pivots.

FIG. 6 shows the top view of articulated vehicle provided with the joint unit according to the invention, connected with running gear joint having twin axle and double pivots, in which case all the axles can be steered in the same direction too.

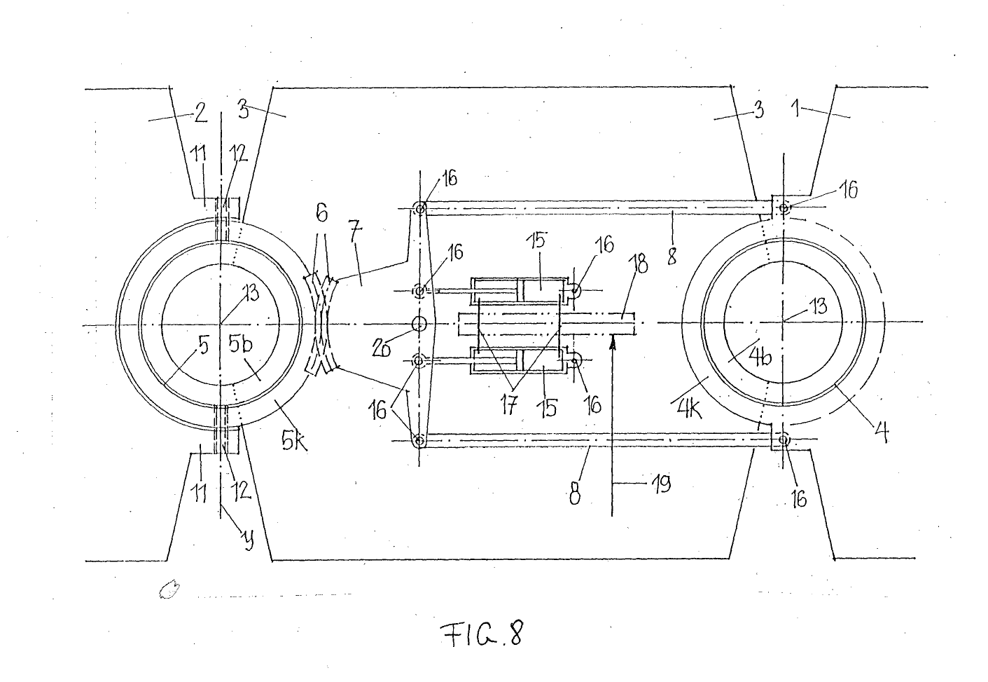

FIG. 7 shows the top view of articulated vehicle provided with the joint unit according to the invention, connected with running gear joint having twin axle and double pivots, where the reduction of rear sweep can be seen, that has been caused by the steering of rear wheels.

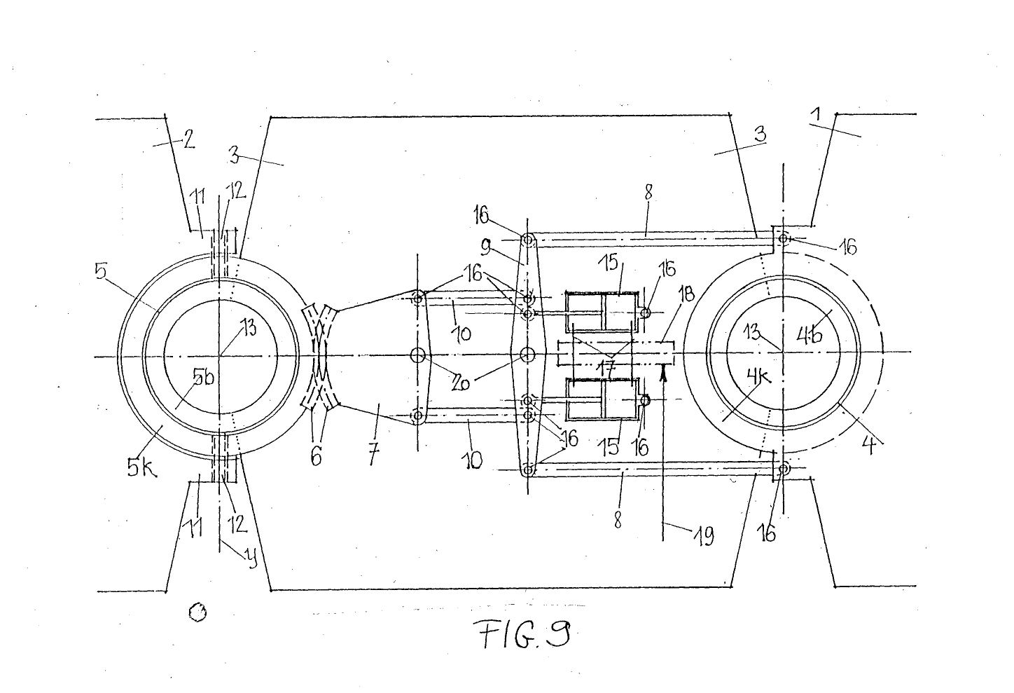

FIG. 8 shows a possible embodiment of the joint unit with double pivots according to the invention.

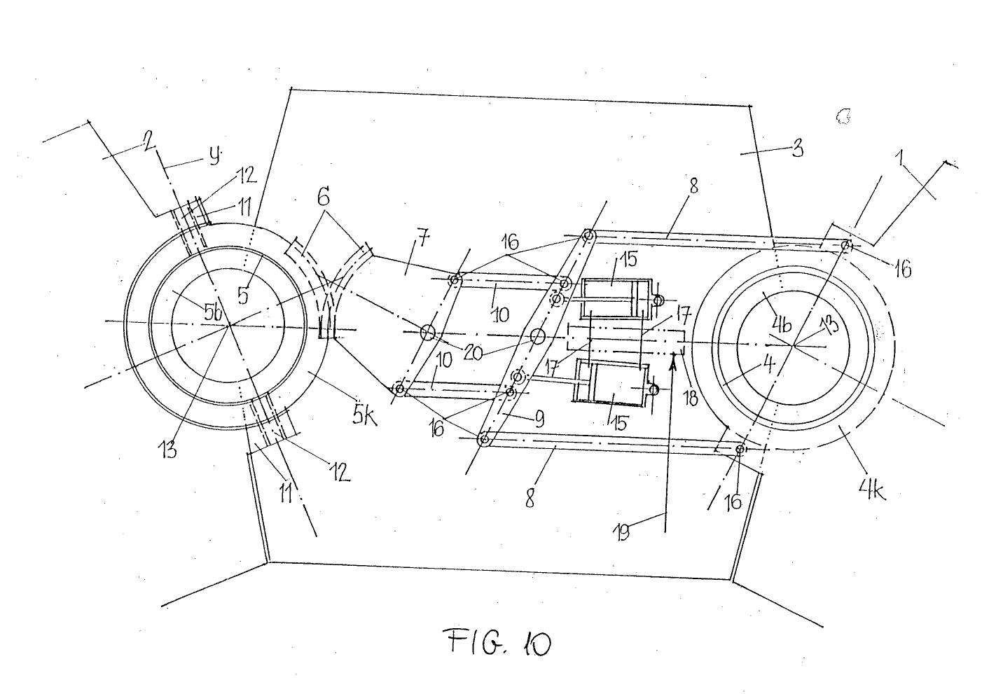

FIG. 9 shows a version of joint unit having double pivot introduced in FIG. 8 as supplemented with an intermediate rocker.

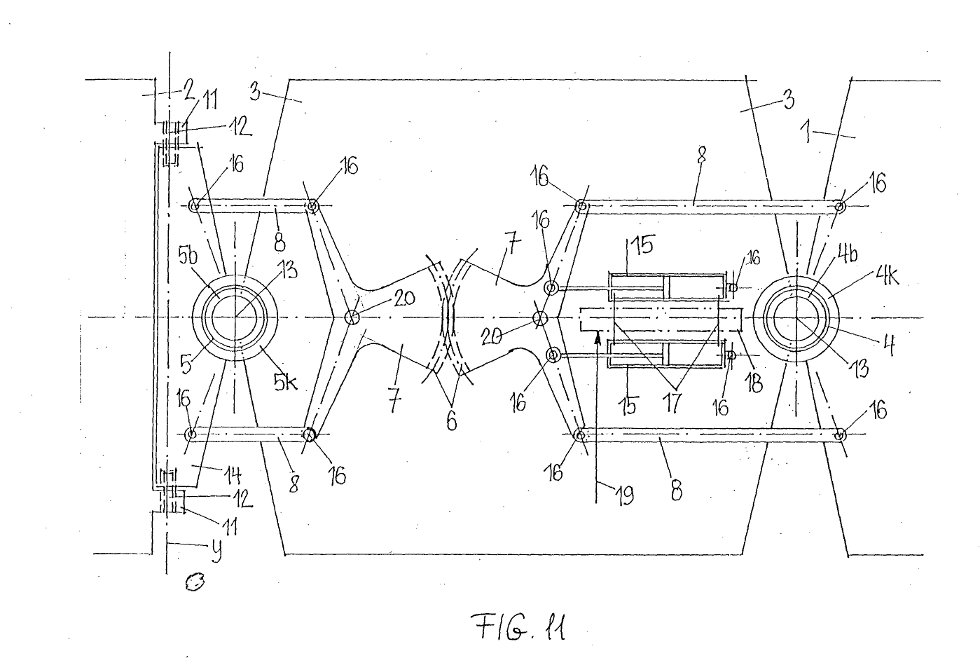

FIG. 10 shows the embodiments of the double pivot joint unit shown in FIG. 9, in a condition while making a turn.

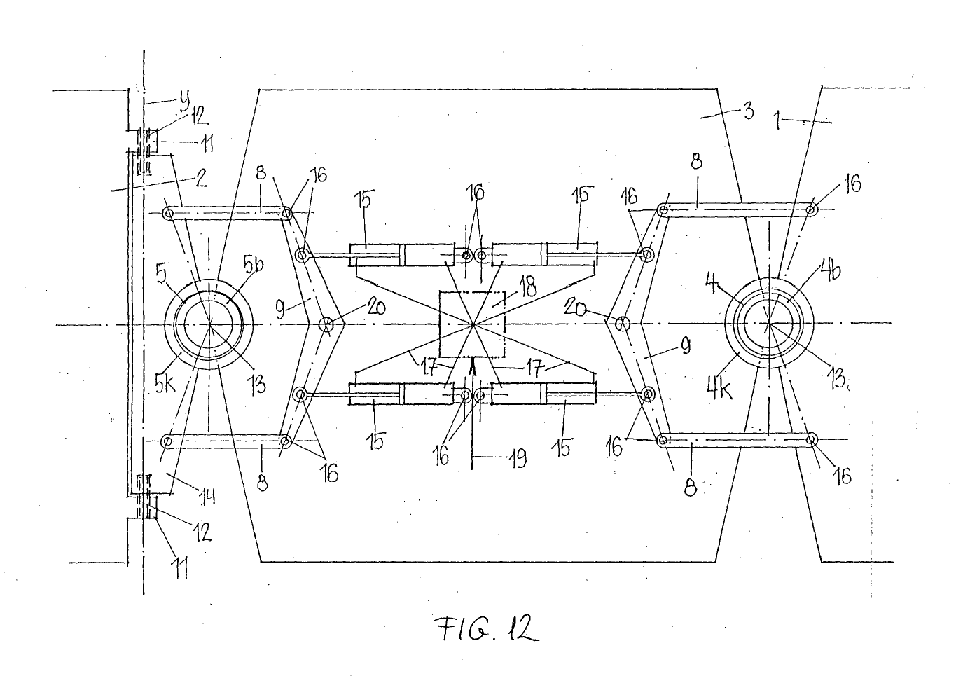

FIG. 11 shows another possible embodiment of the double pivot joint unit according to the invention.

FIG. 12 shows a further possible embodiment of the double pivot joint unit based on hydraulic operation.

FIG. 1 shows the turning properties of the traditional articulated vehicles. As can be seen in FIG. 1, the multiple-axle articulated vehicle has two parts according to the traditional configuration, a front member 100, which is in the given case a towing unit, and the rear member of the vehicle 200, which is in the given case a trailer, and their connection is ensured by a joint 130 which can turn around a vertical axis. In the figure we showed the external radius R and internal radius r of the turning lane S, together with the front steered axle A, the intermediate axle B and the rear axle C. The tilting mass M of the vehicle is shown with hatched lines, which is outside the support points of the wheels.

The towing force is propagated by a pivot, which is supported in bearings, or by the replacing rotating ring. In case of articulated buses, the axles A and B are on the front member'of the vehicle 100, in the given case on a tractor, and the axle C is in the given case on the trailer. Axle A is always steered, while axles B and C are rigid, or axle B is rigid and axle C is counter steered. Double wheels are to be mounted on the middle axle B because of the loads and the drive, or on the rigid axle C working in pushing mode because of the drive, and this significantly reduces the internal space of the vehicle. In the traditional solutions the articulated part needs a space which has a length equivalent to about the width of the vehicle, and only a portion of it can be utilized, and by standing passengers only.

In order to improve the turning ability, the distance between axle B and pivot of joint 130 should be increased, however, this is limited by the tilting of the vehicle body during turning. On the other hand, the axle C is brought closer to the joint 130 in order to meet the requirement about the turning ability, as a result of which the rear overhang of the vehicle body is increased. For this reason the end of the vehicle body swings out from the traffic lane, which is particularly dangerous when the vehicle departs from the side of a sidewalk. The tilting mass M is rather high during the turning of the vehicle, which affects the stability of the vehicle detrimentally. Yet another problem with the traditional articulated solution is that the turning lanes of the vehicle is too wide with the allowed turning radii.

FIG. 2 shows the top view of an articulated vehicle during turning, which has a joint unit 3 according to the invention, and having double pivots and single axle running gear. The front member 1 and the rear member 2 of the vehicle can be seen in the figure, which are connected with the joint unit 3 according to the inventions, which in this case has an intermediate axle B. The items shown in the figure include the external radius R and the internal radius r of the turning lane S, as well as the front steered axle A, the intermediate axle B and the rear axle C. The tilting mass M of the vehicle is indicated with hatched lines in the figure, which is outside the support points of the wheels. As can be seen in the figure, double pivots 13 are included when the joint unit 3 according to the invention is used. As a result of this, the tilting mass M is much less as compared to the one of the traditional articulation solutions, and the width and/or arc of the turning lane S is also less.

FIG. 3 shows the top view of an articulated vehicle during turning, which has a joint unit 3 according to the invention, having twin axle running gear with double pivots. The front member 1 and the rear member 2 of the vehicle can be seen in the figure, which are connected with the joint unit 3 according to the inventions, which in this case has two intermediate twin axles B1, B2. The items shown in the figure include the external radius R and the internal radius r of the turning lane S, as well as the front steered axle A, the intermediate twin axles B1, B2, and the rear axle C. The tilting mass M of the vehicle is indicated with hatched lines in the figure, which is outside the support points of the wheels. The difference relative to the solution shown in FIG. 2 is that twin axles B1, B2 are below the joint unit 3, which improve the load distribution, and at the same time, they do not restrict the internal space of the vehicle.

As can be seen in FIG. 3, double pivots 13 are included also here when the joint unit 3 according to the invention is used. As a result, the tilting mass M is much less in this case also as compared to the traditional articulated solution, and the width and/or arc of the turning lane S is also less.

FIG. 4 shows the top view of a five-member articulated vehicle during turning, which has a joint unit 3 according to the invention, connected with two joint units 3 and running gear having double pivots and twin axles. The front member 1 and the rear member 2 of the vehicle and the intermediate vehicle unit 21 can be seen in the figure, which are connected with the joint unit 3 according to the invention, which in this case have intermediate twin axles B1, B2 and twin axles B3, B4. The items shown in the figure include the external radius R and the internal radius r of the turning lane S, as well as the front steered axle A, the intermediate twin axles B1, B2, B3 B4, and the rear axle C. The tilting mass M of the vehicle is indicated with hatched lines in the figure, which is outside the support points of the wheels. The difference relative to the solution shown in FIG. 3 is that there is an intermediate vehicle unit 21 there are two joint units 3, below which the twin axles B1, B2, B3 B4 are located. In the present case, it is not necessary to install axle below the intermediate vehicle unit 21, because the load distribution is ensured by twin axles B1, B2, B3 B4. The length of a vehicle built in this way can be significantly larger as compared to the examples mentioned above, and at the same time, the width and/or arc of the turning lane S are less than those of traditional vehicles. Also, the tilting mass M does not increase significantly relative to the solutions introduced earlier.

FIG. 5 shows the top vies of articulated vehicle provided with the joint unit 3 according to the invention, connected with running gear joint having twin axle and double pivots. The travel mode of the vehicle provided with joint unit 3 according to the invention is depicted in FIG. 5, when the vehicle moves straight in a direction of the axis of the vehicle.

FIG. 6 shows the top view of articulated vehicle provided with the joint unit 3 according to the invention, connected with running gear joint having twin axle and double pivots, in which case all the axles can be steered in the same direction too. FIG. 6 indicates that if the axle B in the joint unit 3 is steered, and the wheels on all axles A, B, C can be steered in the same direction too, then the departure from the road kerb is possible without rear sweep F with a high probability by steering the wheel simultaneously sideways.

FIG. 7 shows the top view of articulated vehicle provided with the joint unit 3 according to the invention, connected with running gear joint having twin axle and double pivots, where the reduction of rear sweep F can be seen, that has been caused by the steering of rear wheels. In the case shown in FIG. 7, the axles A, C are steered, and axle B is rigid. When the vehicle turns away from the road kerb 22, the rear sweep F of the vehicle configured this way is minimum as compared to the traditional articulated vehicles.

FIG. 8 shows a possible embodiment of the joint unit 3 with double pivots according to the invention. The items shown in the figure include the front member 1 and the rear member 2 of the vehicle, which are connected with the joint unit 3 according to the invention. In one of the pivot 13 of the joint unit 3 located at the part towards the front member 1 there is a rotating ring 4, together with internal ring 4b and external ring 4k forming its parts. In the other pivot 13 of the joint unit 3 located at the part towards the rear member 2 of the vehicle, there is a rotating ring 5, together with internal ring 5b and external ring 5k forming parts of it. One of the sector gear 6 is located on the external ring 5k, which rotates with the other sector gear 6 formed on the matching part of the rocker sector gear 7.

The rocker sector gear 7 is attached to the front member 1 of the vehicle with connecting rods 8. The connecting rods 8 are attached to the front member 1 of the vehicle and to the rocker sector gear 7 with the help of the hinged joint 16. The rocker sector gear 7 is connected to the joint unit 3 on the pivot 20. The figure also shows the hydraulic cylinders 15, which are connected as indicated by the figure through the hinged joint 16 to the rocker sector gear 7 and to the joint unit 3. The hydraulic cylinders 15 are connected to the hydraulic pipes 17 through the control unit 18, to which the travel information and commands coming from the vehicle are transferred through the control port 19.

The rear member 2 of the vehicle is connected to the external ring 5k of the rotating ring 5 through the consol 11 by means of the horizontal shaft 12 having a flexible bedding. In this structural configuration the vehicle is divided into the common unit of the front member 1 and the joint unit 3, and to the unit of the rear member 2 of the vehicle. This allows the rotation around horizontal axis Y, the pitching movement of the vehicle, which is necessary because of the unevenness of the road and the terrain conditions.

FIG. 9 shows a version of joint unit 3 having double pivot introduced in FIG. 8 as supplemented with an intermediate rocker 9. The intermediate rocker 9 divides the connecting rod 8 by two connecting rods 10, which are connected to the rocker sector gear 7. This solution allows to reduce the large deflection length of the connecting rods 8.

FIG. 10 shows the embodiments of the double pivot joint unit 3 shown in FIG. 9, in a condition while making a turn. As can be seen in the figure, the front member 1 and a rear member 2 of the vehicle rotates around pivots 13 within certain limits. The sector gear 6 on the external ring 5k of the rotating ring 5 located between the rear member 2 of the vehicle and the joint unit 3, and the sector gear 6 on the rocker with sector ring 7 rotate relative to each other. The rocker sector gear 7 rotates around pivot 20, and the rotation is determined by the movement of the connecting rods 10, and by the intermediate rocker 9, which is caused by the movement of the connecting rod 8, which in turn is moved by the front member 1 of the vehicle.

During travelling or turning of the vehicle the hydraulic cylinders 15 follow the movement of intermediate rocker 9, and their pistons move in opposite directions. The operation of the hydraulic cylinders 15 is controlled by the commands received through the control port 19 using the hydraulic pipes 17 passed through the control unit 18. This has a special importance in preventing jack-knifing, when the sudden and large turn of the various members of the vehicle is to be prevented. The hydraulic cylinders 15 can hinder the movement of the intermediate rocker 9 upon the action of the control, and therefore the respective members of the vehicle cannot rotate relative to each other at the pivot 13. During normal traffic conditions the hydraulic cylinders 15 act as shock absorbers.

FIG. 11 shows another possible embodiment of the double pivot joint unit 3 according to the invention. In this case two rocker sector gears 7 are used in the joint unit 3 aligned opposite to each other, which are connected with the help of connecting rod 8 to the front member 1 of the vehicle and to the pitching joint 14 placed on the rear member 2 of the vehicle. The pitching joint 14 is connected to the console 11 of the rear member 2 of the vehicle through the flexible embedded horizontal shaft 12. The solution shown in FIG. 11 is different from the solution introduced in FIG. 10 by the fact, that the operation of rocker sector gears 7 is independent of the rotating rings 4, 5. This allows the separation of the various operational functions, which could lead to simpler structural design and higher operating safety. The role and operation of hydraulic cylinders 15 are the same as described with the earlier figures.

FIG. 12 shows a further possible embodiment of the double pivot joint unit 3 based on hydraulic operation. In the present case the joint unit 3 contains a symmetrical configuration consisting of intermediate rockers 9, connecting rods 8 and hydraulic cylinders 15 at the side towards the front member 1 of the vehicle, as well as at the side towards the member 2 of the vehicle. The hydraulic cylinders 15 are connected separately to the joint unit 3 with the help of hinged joint 16. The harmonized operation and control of hydraulic cylinders are ensured by the control unit 18. No sector gear 6 is used in the present case, instead, the identical turn of the intermediate rockers 9 is ensured by the hydraulic cylinders 15.

Possible preferred embodiments and applications of the solution according to the invention:

During the application of the solution according to the invention the properties of the vehicles are made more advantageous by the running gear unified with the joint unit according to the invention. The joint structure unified with running gear includes pivots 13, which pivots 13 have a distance from each other that allows enough space for the wheels of middle axle B when the vehicle bodies articulate while taking a turn. There is a structure in the joint unit 3, which ensures the proportional turn of front member 1 of the vehicle and the rear member 2 of the vehicles, and at the same time, it prevents the undesirable jack-knifing and the pushing over.

As shown in FIG. 1, the supporting surface determined by the supporting points of the wheels during turning in case of the usual articulated vehicles does not coincide with the surface of the straight travel. In case of the solution according to the invention, as shown in FIG. 2, the wheels in the joint unit 3 are close to the turning arc in case of double pivot, the two halves of the vehicle is supported at the corners of quadrangle which is close to the original rectangle.

As can be seen in FIG. 3, the axle B is constructed as twin axles B1, B2, in which case the situation is even better. This construction reduces the tilting caused by the turning to the possible minimum. In case of the preferred embodiment of the solution according to the invention the front member 1 of the vehicle and the rear member 2 of the vehicle are connected to the joint unit 3 by the rotating rings 4, 5. The internal rings 4b, 5b of the rotating rings 4, 5 are connected to the joint unit 3, while their external rings 4k, 5k are connected to the front member 1 of the vehicle and to the rear member 2 of the vehicle.

As can be seen in FIGS. 2 and 3, the wheels must be always steered in the front member 1 of the vehicle on, axle A if the vehicle contains such a joint unit, while the intermediate axle B or the twin axles B1, B2 are installed in the double pivot joint unit 3.

Axle C may be rigid, but a steered axle C is more preferable. As can be seen in FIG. 7, the rear sweep F of the vehicle remains within the allowed limit in the latter case. The wheels in the vehicle can be steered in the same direction also in a manner shown in FIG. 6. As a result of the new joint structure, the turning lane S is about half the allowed value when the vehicle turns according to FIGS. 2 and 3.

A potential danger of the joint unit 3 having pivots 13 is that the joint unit 3 and the rear member 2 of the vehicle may travel behind the front member 1 of the vehicle with different articulation because of road unevenness and other effects during turning; or the joint unit 3 and the front member 1 may jack-knife in pushing mode. For this reason it is necessary to ensure the proportional turning of the vehicle bodies on the one hand, and the protection against jack-knifing shall be ensured on the other hand. Proportional articulation means that the same degree of articulation of the desired total articulation occurs at the pivots 13. The articulation of the vehicle members could be different from one another at the pivots 13, but they are always proportional.

In case of a preferred embodiment of the solution according to the invention, the proportional articulation is ensured by the meshing sector gears 6, which are integrated with the rocker structure with sector gear 7, and they are connected with connecting rods 8 to the front member 1 of the vehicle and to the rear member 2 of the vehicle. In order to reduce the deflection of the connecting rod 8, it is possible to use an intermediate rocker 9. The intermediate rocker 9 and the sector gear 7 are joined by the connecting rod 10. The sector gear 7 and the pivots 20 of the intermediate rocker 9 are mechanically attached to the structure of joint unit 3. The mechanical design of the entire articulating system allows its operation even in case of hydraulic failure. Instead of one of the sector gear 7, the sector gear 6 can be integrated with the external rings 4k, 5k of the rotating ring 4,5. The external and internal arcs of the rotating rings can be interchanged, for instance, the sector gear 6 can be connected to the internal arc 4b or to the internal arc 5b of the rotating ring.

Jack-knifing of the vehicle is prevented by the hydraulic cylinders 15, which are connected to the joint unit 3 at one side, and to the rocker sector gear 7 or to the intermediate rocker 9 at the other side. The connection points are hinged joints 16 that allow rotation, which are connected to the joint unit 3, or to the rocker sector gear 7 or to the intermediate rocker 9. The chambers of the hydraulic cylinders 15 are interconnected by hydraulic pipes 17 passed through the control unit 18. The control unit 18 controls the operation of hydraulic cylinders 15 on the basis of the information and commands received from the vehicle and from the driver's stand through control port 19.

In case of the second embodiment of the structure that ensures proportional turning and preventing jack-knifing shown in FIG. 12, the intermediate rockers 9 are connected to the front member 1 of the vehicle and to the rear member 2 of the vehicle with connecting rods 8. Their pivots 20 are connected to the structure of joint unit 3. Hydraulic cylinders 15 are connected symmetrically to the longitudinal axis of the vehicle with hinged joint 16 to the joint unit 3 at one of their ends, and with hinged joint 16 to the intermediate rocker 9 at their other end. The chambers of the hydraulic cylinders 15 are interconnected through the control unit 18 with the hydraulic pipes 17 that are routed appropriately. The operation of the hydraulic cylinders 15 are controlled by the control unit 18 based on the information received through the control port 19.

During the travel of the articulated vehicle, the axis of the vehicle is broken in vertical plane by the unevenness of the road or when travelling on slope. In case of joint unit having double pivot introduced in FIGS. 9-12, the rotation of the vehicle bodies around axis Y is allowed by the structural joint located at one of the pivots 13 or at its vicinity. In this way the vehicle is “divided into two parts”, i.e. to a separate unit consisting of front member 1 of the vehicle and joint unit 3, and to the attached rear member 2 of the vehicle. In case of the solution according to the invention the roles of the front member 1 of the vehicle and the rear member 2 of the vehicle are interchangeable, because the design of the joint unit 3 allows an operation which is independent of the travel direction. A flexibly embedded horizontal shaft 12 is installed between the consoles 11 of the rear member 2 of the vehicle and the external ring 5k of the rotating ring 5; or the consoles 11 of the rear member 2 of the vehicle are connected with pitching joint 14, which is connected to the external ring 5k of the rotating ring 5, by means of the flexibly embedded horizontal shaft 12. In both cases, the external ring 5k of the rotating ring is connected to the rear member 2 of the vehicle through the flexibly embedded horizontal shaft 12.

The unevenness of the road also causes a lateral tilting of the vehicle during travelling. Considering the width of the vehicle, this tilting has a minor extent, but a rigid structure cannot absorb the load without damage. The protection is provided mostly by the suspension. With the hydro-pneumatic suspension used for instance in large vehicles, the wheels located opposite to each other can be connected in an efficient manner. In case of the solution according to the invention as shown with the embodiments in FIGS. 8-12, a further flexible connection is established by the connection of console 11 of the rear member 2 of the vehicle to the external ring 5k of the joint unit 3 with the flexibly embedded shaft 12. These measures convert the tilting essentially to a pitching.

The advantages of the vehicle built with the joint unit according to the invention are as follows as compared to the presently known solutions:
It ensures improved turning ability relative to the traditional vehicles having similar length, because the vehicle turns with a smaller external arc with this joint unit, or the internal arc of the turning is larger, therefore, the turning lane is smaller.
The length of the vehicle can be increased while complying with the specifications for the turning circle.
The steered axles A, C can be located close to the end of the vehicle, as a result of which the rear sweep F of the vehicle is small.
Smaller then usual articulation is enough at the pivots 13 of the joint unit 3.
As a result of the design of the joint unit 3, the hydraulic cylinders 15 used for preventing jack-knifing can be located at protected places relative to devices having similar function in the traditional articulated vehicles, and can be much smaller.
The joint unit receives axle B or B1, B2, and further joint unit receives the twin axles B3, B4, which can be rigid or steered.
The small turn of steered wheels is enough
All wheels move on the turning arc, there is no slipping
The vehicle can have low flooring even at the articulation
The internal space of the vehicle can be configured in a more flexible manner

The above properties are present in the vehicle simultaneously. The vehicle described above is fully symmetrical in longitudinal direction, therefore it is suitable to travel in both directions, if two driver stands are established. The twin axles allow higher loads too. The size of the vehicles could be increased further, or the turning ability of long vehicles can be improved, if joint unit 3 with multiple axles is used. These vehicles may travel on closed track also as tram or trolley with special permit.

Relative to the traditional articulated solutions, the tilting mass is much less and has better distribution relative to those of the solution according to the invention, which improves the stability of the vehicle significantly.

### LIST OF REFERENCES

1—vehicle front member (towing vehicle)

2—vehicle rear member (trailer)

3—joint unit

4—rotating ring (tractor)

4b—internal ring (rotating ring of tractor) 4k—external ring (rotating ring of tractor)

5—rotating ring (trailer)

5b—internal ring (rotating ring of trailer)

5k—external ring (rotating ring of trailer)

6—sector gear

7—rocker sector gear

8—connecting rod (between the tractor unit and one of the rockers)

9—intermediate rocker

10—connecting rod (between the intermediate rocker and the rocker sector gear)

11—console (trailer or tractor)

12—horizontal shaft (with flexible bedding)

13—pivot (joint unit)

14—pitching joint

15—hydraulic cylinder

16—hinged joint (at the hydraulic cylinders and at linkages)

17—hydraulic pipe (between the hydraulic cylinders)

18—control unit

19—control port (for information and commands)

20—pivot (rockers)

21—intermediate vehicle unit (intermediate trailer)

22—road kerb

100—front member (old type vehicle)

200—rear member (old type vehicle)

130—joint

A—steered front axle

B—intermediate axle

B1, B2, B3, B4—twin axles

C—rear axle

F—rear sweep

M—tilting mass

r—internal radius (of turning lane)

R—external radius (of turning lane)

S—turning lane

Y—horizontal axis (joint)

1. Double pivot joint unit with running gear for road vehicles, which joint unit is located between the front member of the road vehicle and the rear member of the vehicle, and the joint unit has a structure consisting of rocker and linkages for preventing jackknifing and for ensuring proportional turn, which is connected to the front member of the vehicle and to the rear member of the vehicle with rotating rings,
characterised by that,
the joint unit (3) includes the intermediate axle (B) or the vehicle or its twin axle (B1, B2), or the twin axles (B1, B2, B3, B4) of the intermediate joint units (3), and it has double pivots (13) along the longitudinal axis of the vehicle, and a structure that ensures proportional turn of the vehicle members.

2. Joint unit according to claim 1, characterised by that the structure of joint unit (3), that ensures proportional turning, consists of two meshing sectors gears (6), one of which is integrated with one of the rings (4k, 5k) of one of the rotating ring (4,5), while the other sector ring (6) or both of them are integrated with a respective rocker sector gear (7), and the rocker sector gears (7) are connected directly with connecting rods (8), or through pitching joint (14) to the vehicle members (1, 2).

3. Joint unit according to claim 2, characterised by that the two rocker sector gears (7) are used in the joint unit (3), which are connected to the front member (1) of the vehicle and to the rear member (2) of the vehicle with connecting rods (8) by means of hinged joint (16).

4. Joint unit according to claim 1, characterised by that rotating rings (4, 5) are installed in its pivots (13) at identical centres, one ring (4b, 5b) of which are connected to the joint unit (3) and the other ring (4k, 5k) of which are connected to the vehicle members (1, 2), and one of the vehicle member is connected to pitching joint (14) which is capable of rotating around a horizontal axis (Y).

5. Joint unit according to claim 1, characterised by that a structure for preventing jackknifing is installed symmetrically to the longitudinal axis of the vehicle, where hydraulic cylinders (15) are connected through hinged joint (16) to the structure of joint unit (3) and to the rocker sector gear (7) or to the intermediate rocker (9); and their chambers are interconnected with hydraulic pipes (17) passed through the control unit (18), and the control unit (18) works on the basis of information collected from the vehicle and commands received from the driver's stand through the control port (19).

6. Joint unit according to claim 1, characterised by that in its structure ensuring proportional articulation the radii of sector gears (6) may be different, and/or the alignment of connecting rods (8, 10) may deviate from the parallel.

7. Joint unit according to claim 1, characterised by that hydraulic cylinders (15) located symmetrically to the longitudinal axis of the vehicle combine the two functions of the structure of the joint unit (3), which ensures proportional articulations and provides protection against jack-knifing, which are connected to the structure of joint unit (3) at one side, and are connected at the other side to the intermediate rockers (9) with hinged joint (16), while the intermediate rockers (9) are connected to the vehicle members (1, 2) through the connecting rods (8), and the chambers of the hydraulic cylinders (15) are interconnected with hydraulic pipes (17), which are passed through control unit (18) and routed properly, and the control unit operates the hydraulic cylinders (15) on the basis of the information received from the vehicle through control port (19) and the commands received from the driver's stand.

8. Joint unit according to claim 1, characterised by that the pitching movement of the vehicle is ensured by the pitching joint (14) by means of the flexibly embedded horizontal shaft (12) installed between the consoles (11) and one of rings (5k) of the rotating ring (5) of one of the vehicle member (2); or by means of the flexibly embedded horizontal shaft (12) installed between the console (11) of the vehicle member and pitching joint (14) integrated with one of rings (5k) of the rotating ring (5).

9. Joint unit according to claim 1, characterised by that the twin axles (B1, B2, B3 B4) of the joint unit (3) are established with axle steering.

10. Joint unit according to claim 1, characterised by that more than one, in the given case two joint units (3) are used between the front member (1) of the vehicle and the rear member (2) of the vehicle, which are connected to an intermediate vehicle unit (21).
